(19) United States
(12) Patent Application Publication
(10) Pub. No.: US 2021/0170955 A1
(43) Pub. Date: Jun. 10, 2021

(54) VEHICLE BICYCLE CARRIER WITH ROTATING POST

(71) Applicant: Hollywood Engineering, Inc., Los Angeles, CA (US)

(72) Inventor: Neil Nusbaum, Culver City, CA (US)

(21) Appl. No.: 16/854,544

(22) Filed: Apr. 21, 2020

Related U.S. Application Data
(60) Provisional application No. 62/945,673, filed on Dec. 9, 2019.

(51) Int. Cl. B60R 9/10; B60R 9/06

(52) U.S. Cl. CPC B60R 9/10; B60R 2011/004; B60R 9/06

(57) ABSTRACT

A trailer hitch mounted vehicle bike carrier with bicycle wheel supporting trays that may be configured to hold the bicycle at various locations of the bike's frame or seat post with a clamp. The clamp may be slidably attached to a U-shaped clamping frame that may be located between the bikes, wherein the clamping frame may be of round tubing parallel to the rear of the vehicle. When the bikes are not mounted for transport, the clamping frame is configured to rotate about 90 degrees so that it may be perpendicular to the rear of the vehicle and fold down so as to be resting on or above the bike carrier's wheel trays. The bike carrier may then be deployed to a stowed position against the rear of the vehicle.

### CROSS-REFERENCE TO RELATED APPLICATIONS

This Application claims the benefit of and priority to U.S. Provisional Patent Application No. 62/945,673, filed on Dec. 9, 2019, titled “VEHICLE BICYCLE CARRIER WITH ROTATING POST”, the contents of which are expressly incorporated herein by this reference as though set forth in their entirety.

### FIELD OF USE

The present disclosure relates generally to vehicle racks and, in particular, to a vehicle rack for bicycles that has a rotating post.

### BACKGROUND

Bicycles may generally be secured to a vehicle through various racks and carriers. One type of rack that is mounted to a vehicle is the hitch mounted carrier (sometimes referred to as a rack). The bicycle may be attached to the rack by either hanging them on supporting arms or securing them in such a manner that their tires rest on a tray or an equivalent platform type of device. There are numerous ways and devices to secure the bike on the tray, one of which is to use a clamp that may hold the bike by either its frame or seat post. Due to the wide variety of bicycles on the market, which now includes electric bikes, there often is no simple or common locations to attach the clamp to the bike. In the case of electric bikes, frames often have batteries attached to them, and many bikes use a shock absorbing seat post making the seat post unable to accept a clamp. Therefore, the clamp must be free to secure the bike's frame in different places or should be generally available to secure the seat post. This can be accomplished via a long, solidly mounted ‘clamping frame’ that may be parallel to both the bike and the rear of the vehicle. In this manner, the clamp may have multiple, slidable positions. One useful feature of some carriers is the ability to fold upward and/or flat against the rear of the vehicle when not in use. To fold the carrier flat against the vehicle, the clamping frame must also be folded, removed, or moved so as not to interfere or make contact with the vehicle when the carrier is put into the folded position.

U.S. Published Patent Application No. 2007/0108245 discloses a non-folding bike carrier with the clamping frame located at the front of the carrier. The bike closest to the frame usually has no difficulty getting the clamp into a desired position, but the outer bike's clamp may have interference issues due to the presence of the first bike. This deficiency may be resolved by placing the clamping frame between the two bikes.

U.S. Pat. No. 6,019,266 discloses a center mounted clamping post with slidable clamps located between the bikes. Other prior systems disclose that the center post can be rotated sideways to facilitate bike carrier foldup against the rear of the vehicle. However, the disadvantage with the single post design (or narrow U-frame design) is that the slidable clamps are restricted to vertical motion only, greatly limiting available clamping locations. The bike can be laterally repositioned for a better clamping location, however, this may cause the bike's front or rear wheel to extend beyond the width of the vehicle, especially if mounted to a narrow automobile.

U.S. Pat. No. 8,235,267 discloses a carrier with a center inverted “U-frame” that can pivot sideways and can fold flat against the vehicle. This carrier utilizes sliding hooks to “press” the bike frame down into the wheel trays, rather than a clamp to grab the frame or seat post. When using sliding hooks to hold down the bike, there is no mechanical need for multiple “press down” locations, because the hook will make contact with the bike's top tube (or top tube adapter for step-thru style frames). The disadvantage of the “press down” hook is that they do not always work with certain types of bikes, such as electric bikes. For those applications, the frame/seat post clamp would be necessary.

Most bike carriers currently on the market using the U-shaped clamping frame located between the bikes have a clamping frame width of approximately 18″ to 30″. This allows for a wide range of clamping locations. To deploy the bike carrier to a folded position flat against the vehicle, the clamping frame must be either removed or folded out of the way. With the clamping frame parallel to the rear of the vehicle, the clamping frame must rotate forward, so it is lying on top of the trays. Functionally, this allows the bike carrier to be deployed to its folded position flat against the vehicle, however, the clamping frame may extend 24″ to 36″ above the tray when the bike carrier is folded. This is functionally, visibly, and esthetically inconvenient.

Thus, what is needed is a bike carrier rack wherein the clamping frame can be rotated at least 90 degrees from parallel to perpendicular to the rear of the vehicle and then hinged down so it is lying above or on top of the wheel trays, which then allows the bike carrier to be deployed to a folded position flat against the vehicle. Before the device of the present disclosure no system has featured a rotating post.

### SUMMARY

The following presents a simplified overview of the example embodiments in order to provide a basic understanding of some embodiments of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented hereinbelow. It is to be understood that both the following general description and the following detailed description are exemplary and explanatory only and are not restrictive.

One embodiment may be a trailer hitch mounted automotive bike carrier with bicycle wheel supporting trays and the ability to hold the bicycle at various locations of its frame or seat post with a clamp. The clamp may be slidably attached to a U-shaped clamping frame located between the bikes, the clamping frame may be of round tubing parallel to the rear of the vehicle. When the bikes are not mounted for transport, the clamping frame is rotated 90 degrees so as to be perpendicular to the rear of the vehicle and fold down so as to be resting on or above the bike carrier's wheel trays. The bike carrier can then be deployed to a stowed position against the rear of the vehicle. When the clamping frame is rotated 90 degrees then folded down, and the bike carrier deployed to its folded position, the vertical tubes of the clamping frame can be positioned very close to (and potentially matingly engaged with) the carrier's wheel trays, allowing for a more streamlined and attractive stowed appearance. It also allows for a smaller required area when not in use and stored in a garage or the equivalent.

In one embodiment, the sequence of steps to bring the carrier from a bike transporting position to a stowed position may be:
1. Remove the bicycle from the carrier,
2. Unlock and rotate the clamping frame (approximately 90 degrees) from the parallel (to the rear of the vehicle) orientation (or position) to the perpendicular (to the rear of the vehicle) orientation (or position)
3. Lock the clamping frame into the perpendicular position
4. Unlock and hinge the clamping frame down (approximately 90 degrees) so that the clamping frame is in a folded position above and parallel to the wheel support tray
5. Unlock and rotate the wheel support base to a stowed position parallel to and flipped up against the rear of the vehicle

One embodiment may be a vehicle rack comprising: a carrier base; a clamping post; and a clamping frame base hinge/bracket; wherein the clamping post comprises a clamping frame assembly, a clamping post housing, and a rotating post base; wherein the carrier base is attached to and supports the clamping frame base hinge/bracket and wherein the clamping frame base hinge/bracket is attached to the clamping post housing; wherein the clamping post base is rotatable with respect to the clamping post housing and has at least two positions, an in-use position and a rotated position; wherein the clamping post is configured to hinge with respect to the carrier base and has at least two positions, an-in use position and a stowed position; and wherein the carrier base is configured to support a load and wherein the clamping frame assembly is configured to removeably engage with the load. The vehicle rack may also include a hitch stinger and a carrier foldup bracket, wherein the hitch stinger may be configured to removeably attach to a trailer hitch receiver of a vehicle. The carrier base may comprise one or more wheel support trays and a wheel support beam. The wheel support beam may be attached to the carrier foldup bracket and the hitch stinger may be attached to the carrier foldup bracket, such that the carrier base is configured to hinge with respect to the hitch stinger, such that the vehicle rack has at least two positions, an in-use position and a stowed position. The clamping post housing may be hingedly attached to the clamping frame base hinge/bracket via a pivot bolt. The clamping frame base hinge/bracket may comprise an in-use hole and a stowed hole, which are configured to allow the clamping post to be locked into the in-use position and the stowed position. The clamping post housing may comprise a post lock. The rotating post base may have at least one side index hole and at least one front index hole, wherein the post lock is configured to engage, alternatively, with the at least one side index hole and the at least one front index hole, such that the rotating post base is configured to be locked into the in-use position and the rotated position; and wherein the in-use position and the rotated position may be approximately 90 degrees from each other. The clamping frame assembly may comprise a clamping tube and one or more bike engagement portions. The load may be one or more bicycles. The one or more bike engagement portions may comprise a bike clamp, a frame clamp adapter, and a bike clamp position tube. The one or more bike engagement portions may be configured to be adjustably connected to the clamping tube and may be configured to releasably engage with the one or more bicycles.

Another embodiment may be a vehicle rack comprising: a carrier base; a clamping post; a clamping frame base hinge/bracket; a hitch stinger; and a carrier foldup bracket; wherein the clamping post comprises a clamping frame assembly, a clamping post housing, and a rotating post base; wherein the carrier base is attached to and supports the clamping frame base hinge/bracket and wherein the clamping frame base hinge/bracket is hingedly attached to the clamping post housing via a pivot bolt; wherein the clamping post base is rotatable with respect to the clamping post housing and has at least two positions, an in-use position and a rotated position; wherein the clamping post is configured to hinge with respect to the carrier base and has at least two positions, an-in use position and a stowed position; wherein the carrier base is configured to support a load and wherein the clamping frame assembly is configured to removeably engage with the load; wherein the hitch stinger is configured to removeably attach to a trailer hitch receiver of a vehicle; wherein the carrier base comprises one or more wheel support trays and a wheel support beam; wherein the wheel support beam is attached to the carrier foldup bracket; wherein the hitch stinger is attached to the carrier foldup bracket, such that the carrier base is configured to hinge with respect to the hitch stinger, such that the vehicle rack has at least two positions, an in-use position and a stowed position. The clamping frame base hinge/bracket may comprises an in-use hole and a stowed hole, which are configured to allow the clamping post to be locked into the in-use position and the stowed position. The clamping post housing may comprise a post lock. The rotating post base may have at least one side index hole and at least one front index hole. The post lock may be configured to engage, alternatively, with the at least one side index hole and the at least one front index hole, such that the rotating post base is configured to be locked into the in-use position and the rotated position. The in-use position and the rotated position may be approximately 90 degrees from each other. The clamping frame assembly may comprise a clamping tube and one or more bike engagement portions. The load may be one or more bicycles. The one or more bike engagement portions may comprise a bike clamp, a frame clamp adapter, and a bike clamp position tube. The one or more bike engagement portions may be configured to be adjustably and slidably connected to the clamping tube and may be configured to releasably engage with the one or more bicycles. Preferably, when the clamping post is locked into the stowed position, the clamping tube matingly fits with the one or more wheel support trays.

Another embodiment may be a vehicle rack comprising: a carrier base; a clamping post; and a clamping frame base hinge/bracket; wherein the clamping post comprises a clamping frame assembly, a clamping post housing, and a rotating post base; wherein the carrier base is attached to and supports the clamping frame base hinge/bracket and wherein the clamping frame base hinge/bracket is attached to the clamping post housing; wherein the clamping post base is rotatable with respect to the clamping post housing and has at least two positions, an in-use position and a rotated position; wherein the clamping post is configured to hinge with respect to the carrier base and has at least two positions, an-in use position and a stowed position; wherein the carrier base is configured to support a load and wherein the clamping frame assembly is configured to removeably engage with the load; wherein the clamping frame base hinge/bracket comprises an in-use hole and a stowed hole, which are configured to allow the clamping post to be locked into the in-use position and the stowed position. The vehicle rack may further comprise a hitch stinger and a carrier foldup bracket; wherein the hitch stinger may be configured to removeably attach to a trailer hitch receiver of a vehicle; wherein the carrier base may comprise one or more wheel support trays and a wheel support beam; wherein the wheel support beam may be attached to the carrier foldup bracket; wherein the hitch stinger may be attached to the carrier foldup bracket, such that the carrier base is configured to hinge with respect to the hitch stinger, such that the vehicle rack has at least two positions, an in-use position and a stowed position. The clamping post housing may be hingedly attached to the clamping frame base hinge/bracket via a pivot bolt. The clamping post housing may comprise a post lock. The rotating post base may have at least one side index hole and at least one front index hole. The post lock may be configured to engage, alternatively, with the at least one side index hole and the at least one front index hole, such that the rotating post base is configured to be locked into the in-use position and the rotated position. The clamping frame assembly may comprise a clamping tube and one or more bike engagement portions. The load may be one or more bicycles. The one or more bike engagement portions may comprise a bike clamp, a frame clamp adapter, and a bike clamp position tube. The one or more bike engagement portions may be configured to be adjustably connected to the clamping tube and may be configured to releasably engage with the one or more bicycles. The rotating post base in-use position and the rotating post base rotated position may be approximately 90 degrees from each other.

Still other advantages, embodiments, and features of the subject disclosure will become readily apparent to those of ordinary skill in the art from the following description wherein there is shown and described a preferred embodiment of the present disclosure, simply by way of illustration of one of the best modes best suited to carry out the subject disclosure As it will be realized, the present disclosure is capable of other different embodiments and its several details are capable of modifications in various obvious embodiments all without departing from, or limiting, the scope herein. Accordingly, the drawings and descriptions will be regarded as illustrative in nature and not as restrictive.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is an illustration of a perspective view of one embodiment of the vehicle rack with a rotating post.

FIG. 2 is an illustration of a perspective view of one embodiment of the vehicle rack showing the post base hinge/bracket.

FIG. 3 is an illustration of a perspective view of one embodiment of the vehicle rack with a rotating post that is attached to a vehicle and is ready to receive and engage a load.

FIG. 4a is an illustration of a perspective view of one embodiment of the clamping post of a vehicle rack.

FIG. 4b is an illustration of a front and cut-away view of one embodiment of the clamping post of a vehicle rack.

FIG. 5 is an illustration of a perspective view of one embodiment of the vehicle rack with a rotating post that has been rotated.

FIG. 6 is a perspective view of one embodiment of the vehicle rack with a rotating post that has been rotated and that is attached to a vehicle.

FIG. 7 is an illustration of a close-up view of one embodiment of the clamping frame base hinge/bracket with the clamping post being hinged downward.

FIG. 8 is an illustration of a close-up side view of one embodiment of the clamping frame base hinge/bracket with the clamping post in a stowed position.

FIG. 9 is an illustration of a perspective view of one embodiment of the vehicle rack with the rotating post in a stowed position.

FIG. 10 is an illustration of a perspective view of one embodiment of the vehicle rack in a stowed position and attached to a vehicle.

FIGS. 11a-f are a series of illustrations showing one embodiment of the vehicle rack going from a loaded position to a stowed position.

### DETAILED DESCRIPTION OF THE EMBODIMENTS

Before the present methods and systems are disclosed and described, it is to be understood that the methods and systems are not limited to specific methods, specific components, or to particular implementations. The methods and systems disclosed and described herein may be understood more readily by reference to the following detailed description of preferred embodiments and the examples included therein and to the Figures and their previous and following description. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where the event or circumstance occurs and instances where it does not.

The term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item or result.

As used herein, the terms “approximately” and “about” generally refer to a deviance of within 5% of the indicated number or range of numbers. In one embodiment, the term “approximately” and “about” may refer to a deviance of between 0.001-10% from the indicated number or range of numbers. Unless otherwise stated, all measurements, values, ratings, positions, magnitudes, sizes, locations, and other specifications that are set forth in this specification, including in the claims that follow, are approximate, not exact. They are intended to have a reasonable range that is consistent with the functions to which they relate and with what is customary in the art to which they pertain.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

Various embodiments are now described with reference to the drawings. In the following description, for purposes of explanation, numerous specific details are set forth in order to provide a thorough understanding of one or more embodiments. It may be evident, however, that the various embodiments may be practiced without these specific details.

Before the present methods and systems are disclosed and described in detail, it is to be understood that the methods and systems are not limited to specific methods, specific components, or to particular implementations. It is also to be understood that the terminology used herein is for the purpose of describing particular embodiments only and is not intended to be limiting.

### REFERENCE NUMBER LEGEND

100—Vehicle rack (carrier)

101/102—Wheel support tray

103—Carrier foldup bracket

104—Clamping frame (post) base hinge/bracket

105—Clamping frame assembly

106—Clamping tube

107—Clamping post

108—Clamping post housing (base)

109—Rotating post base

110—Post Lock

111—Side index holes

112—Front index holes

113—L pin

114—Hole for stored position

115—Hole for in use position

116—Pivot bolt (hinge pin)

120—Carrier base

127—Trailer hitch receiver

128—Wheel support beam

129—Pivot bolt

130—Stowed position lock

131—In use position lock

132—Hitch stinger

133—Bike clamp

134—Tightening knob with bolt

135—Frame clamp adapter

136—Bike clamp position tube

199—Bike engagement portions

300—Vehicle

800—Post Stop Portion

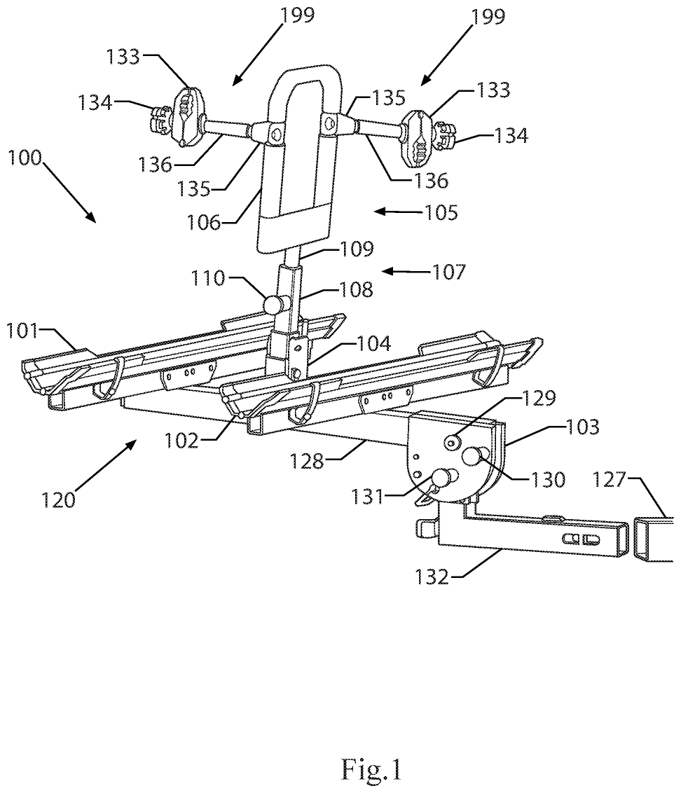

FIG. 1 is an illustration of a perspective view of one embodiment of the vehicle rack with a rotating post. As shown in FIG. 1, the vehicle rack 100 may comprise a carrier base 120, a carrier fold-up bracket 103, a clamping frame base hinge/bracket 104, and clamping post 107. The parts of the vehicle rack may be made from a strong material, such as steel, iron, or aluminum. The carrier base 120 may be configured to support and engage with a load, such as one or two bicycles. The carrier base may comprise wheel support trays 101, 102, and a wheel support beam 128. As shown the wheel support beam 128 may extend distally away from the vehicle to which the vehicle rack 100 is configured to engage. The wheel support beam 128 may be attached (permanently (such as through welding) or removeably (such as using bolts) to the wheel support trays 101, 102. As shown, the carrier base 120 is configured to, in a balanced manner, support one or two bicycles by engaging the tires of the bicycles.

The wheel support beam 128 may be connected (preferably permanently via welding) to the carrier foldup bracket 103, such that when the carrier base is put into a stowed position, the wheel support beam 128 moves with the carrier foldup bracket 103 as it hinges upward. The carrier foldup bracket 103 may be connected to the hitch stinger 132 via pivot bolt 129. The carrier foldup bracket may further comprise stowed position lock 130 and in-use position lock 131. As shown the in-use position lock 131, which may be a spring-loaded pull knob pin, may lock the wheel support beam 128 into an in-use position. When the user wants to fold up the vehicle rack, the user may pull out the knob of the in-use position lock 131, which may allow the carrier fold up bracket 103 to hinge upward with respect to the hitch stinger 132. Once in the folded-up position (stowed position), the user may lock the carrier into the stowed position by engaging the stowed position lock 130, which may also be a spring-loaded pull knob pin. The hitch stinger 132 is configured to slide into the trailer hitch receiver 127, which may be attached to the vehicle. The hitch stinger 132 and the trailer hitch receiver 127 may be locked together via a pin or via a spring/push latch.

The carrier base 120 may preferably be attached to the post base hinge/bracket 104. This attachment is preferably a permanent attachment, such as through welding. The post (or clamping frame) base hinge/bracket 104 may be hingedly attached to the clamping post 107, such that clamping post 107 may have an in-use (up right) position and a stowed (folded down) position.

The clamping post 107 may comprise a clamping post housing 108, which may be configured to be the base of the clamping post 107 and may directly engage with the clamping frame base hinge/bracket 104. The clamping post 107 may further comprise rotating post base 109 and clamping frame assembly 105. The clamping frame assembly 105 may comprise clamping tube 106 and one or more bike engagement portions 199. Although a U-shaped clamping tube 106, as shown, is preferred (because it allows the bike engagement portions to be easily slid along an entire length), any shape may be used, including circular, rectangular, or a single rod/post. As shown, the bike engagement portions 199 may comprise frame clamp adapter 135, a bike clamp position tube 136, a bike clamp 133, and a tightening knob with bolt 134. Preferably, each bike clamp 133 is configured to engage a bicycle that is loaded onto the rack 100. The frame clamp adapter may be configured to releaseably hold the bike engagement portion 199 on to the clamping tube 106, such that the bike engagement portion 199 may be positioned and re-positioned along the length of the clamping tube 106. The tightening knob with bolt 134 may allow the user to engage and disengage the bike clamps 133.

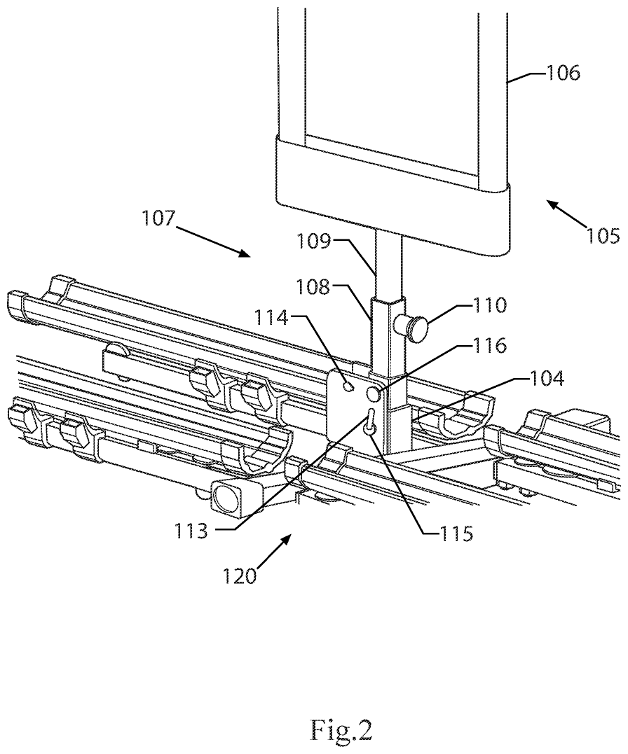

FIG. 2 is an illustration of a perspective view of one embodiment of the vehicle rack showing the post base hinge/bracket. As shown in FIG. 2, the clamping post base 108 may preferably fit into clamping post housing 108 and be locked in place by post lock 110. Post lock 110 may be a spring-loaded pull knob pin, but may be any mechanism that that releasably locks the post base 108 into the housing 109, may be used, including an L pin. Although the post base 109 and the clamping tube 106 are shown as two separate pieces of the clamping frame assembly 105, it should be understood that the clamping frame assembly 105 may be a unitary structure and may be of any shape that allows it to engage with and/or secure one or more bikes.

FIG. 2 also shows that the clamping post 107, via clamping post housing 108, may hingedly connect to clamping frame base hinge/bracket 104 at pivot bolt 116. Pivot bolt 116 essentially acts as a hinge pin at which the clamping post may hinge up or down relative to clamping frame base hinge bracket 104 and carrier base 120. As shown the post 107 may be locked into an in-use position by L pin 113 going through hole for in-use position 115. In some embodiments, the L pin 113 may be a spring-loaded pull knob pin. When the L pin 113 is removed, the post 107 may hinge down into a stowed position and then locked into this stowed position via the L pin 113 going through the hole for stored position. The clamping post housing 108 may have a hold or notch that the L pin 113 is also engaging with when the post is locked into the stored or in-use positions.

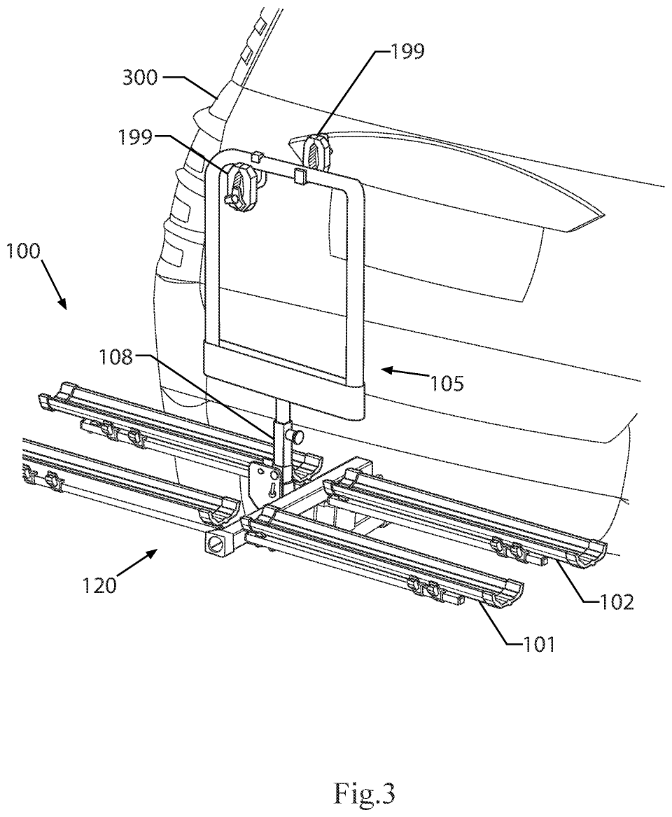

FIG. 3 is an illustration of a perspective view of one embodiment of the vehicle rack with a rotating post that is attached to a vehicle and is ready to receive and engage a load. FIG. 3 shows that the vehicle rack may be engaged with a vehicle 300 and may be configured to securely hold one or two bikes. FIG. 3 shows that the clamping frame assembly may be in a parallel (to the vehicle 300 and the wheel support trays 101, 102) configuration when it is ready to engage with the bikes. FIG. 3 also shows how the bike engagement portions have been moved to a different location on the clamping frame assembly 105.

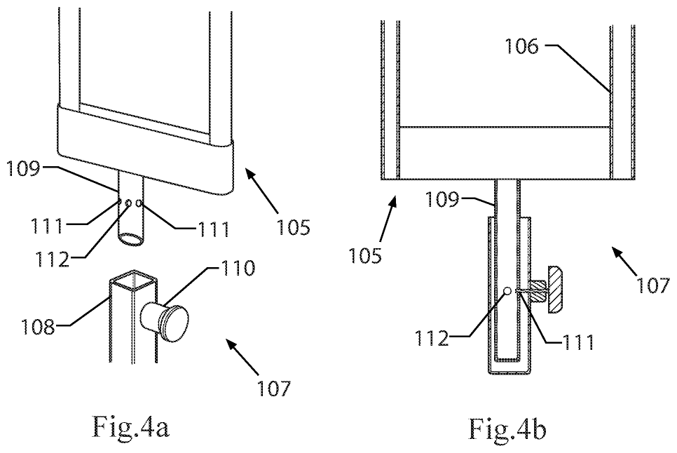

FIG. 4a is an illustration of a perspective view of one embodiment of the clamping post of a vehicle rack. FIG. 4a shows that the clamping post may comprise clamping frame assembly 105 and clamping post housing 108. The clamping frame assembly 105 may comprise a rotating post base 109 that comprises side index holes 111 and front index holes 112. The index holes 111, 112 are holes or notches that a pin may releasably engage so as to lock the clamping frame assembly 105 to the clamping post housing 108 using a post lock 110.

FIG. 4b is an illustration of a front and cut-away view of one embodiment of the clamping post of a vehicle rack. FIG. 4b shows that the clamping post may comprise clamping frame assembly 105 and clamping post housing 108. The clamping frame assembly 105 may comprise a clamping tube 106 and rotating post base 109, which may comprise side index holes 111 and front index holes 112. When the clamping frame assembly 105 may be in the in-use position, the post lock engages with side index holes 111. FIG. 4b shows that rotating post base 109 fits within clamping post housing 108, and that they may rotate at least 90 degrees with respect to one another.

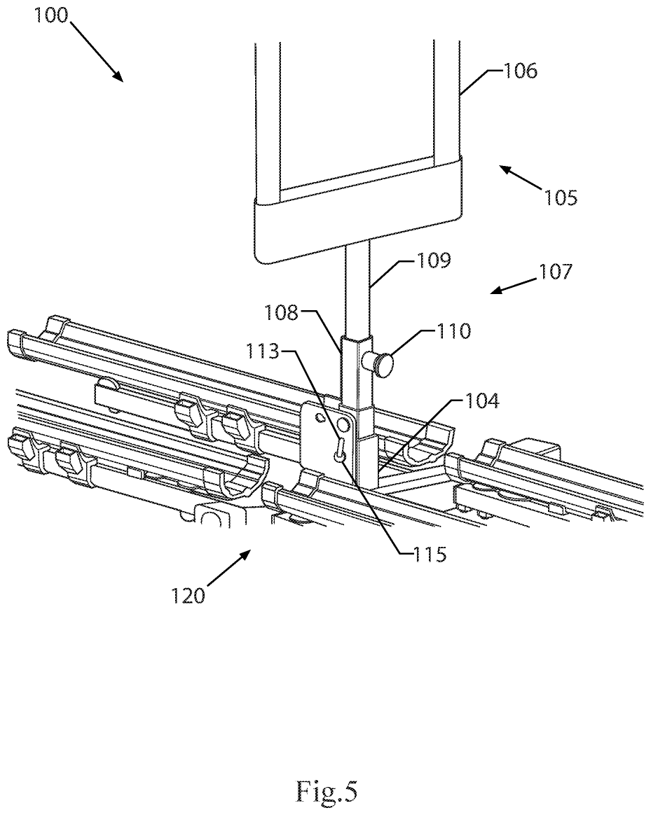

FIG. 5 is an illustration of a perspective view of one embodiment of the vehicle rack with a rotating post that has been rotated. As shown in FIG. 5, the clamping frame assembly 105 may be turned or rotated 90 degrees to be perpendicular to the wheel support trays 101, 102. The post lock 110 may lock the rotating post base 108 into place.

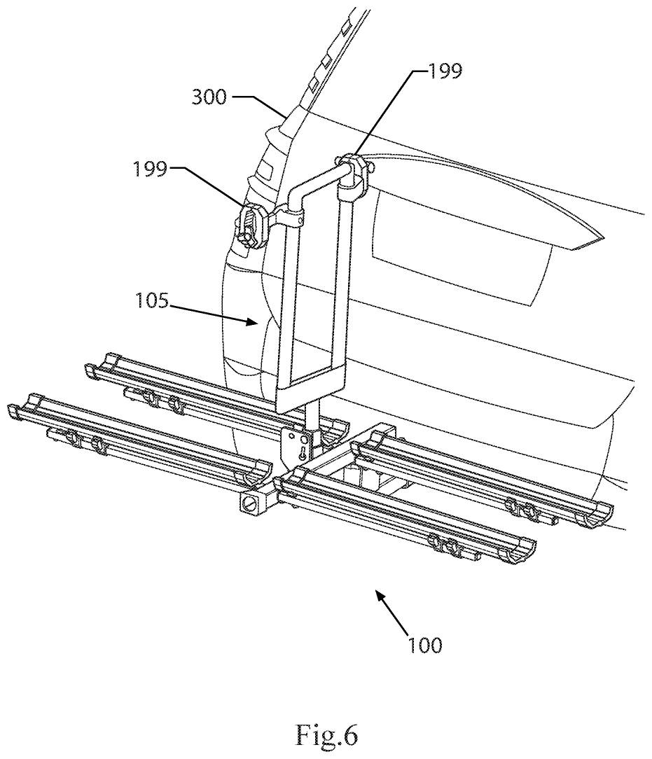

FIG. 6 is a perspective view of one embodiment of the vehicle rack with a rotating post that has been rotated and that is attached to a vehicle. As shown in FIG. 6, the rack 100 may be engaged with a vehicle 300. The clamping frame assembly 105 of rack 100 may be perpendicular to the vehicle when in the not-in-use position. FIG. 6 also shows another position in which the bike engagement portions 199 may be.

Although the drawings show that the clamping frame assembly 105 is entirely disengageable from the clamping post housing 108, in some embodiments, the two portions may be rotatable, but not disengageable.

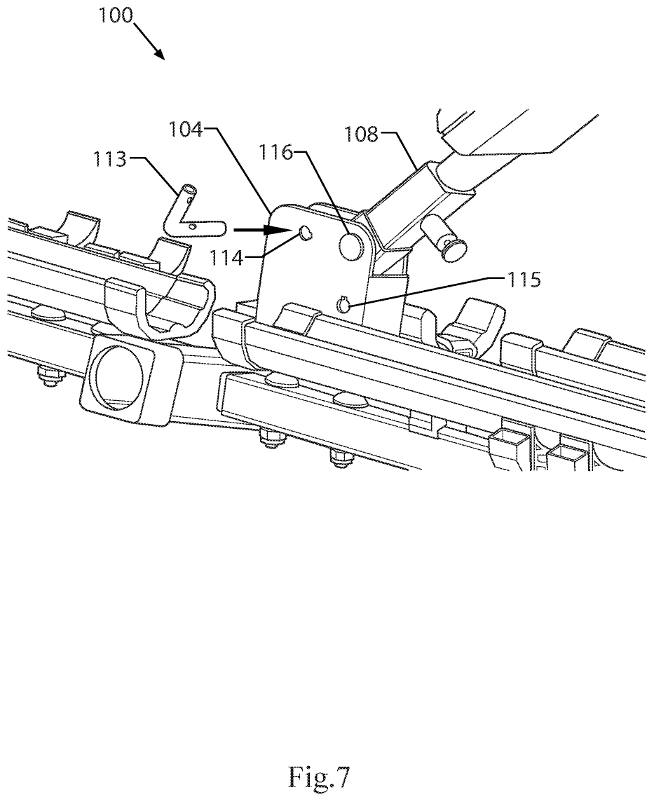

FIG. 7 is an illustration of a close-up view of one embodiment of the clamping frame base hinge/bracket with the clamping post being hinged downward. When the L pin 113 is removed from hole 115, the clamping post 107 may be hinged downward from an upright in-use position to a down/stowed position. The clamping post 107 hinges via pivot bolt 116, which is held securely by the clamping frame base hinge/bracket 104. Once the clamping post 107 is hinged the approximately 90 degrees to a stowed position, the L pin 113 may be inserted in to hole 114, which locks the clamping post 107 into the stowed position.

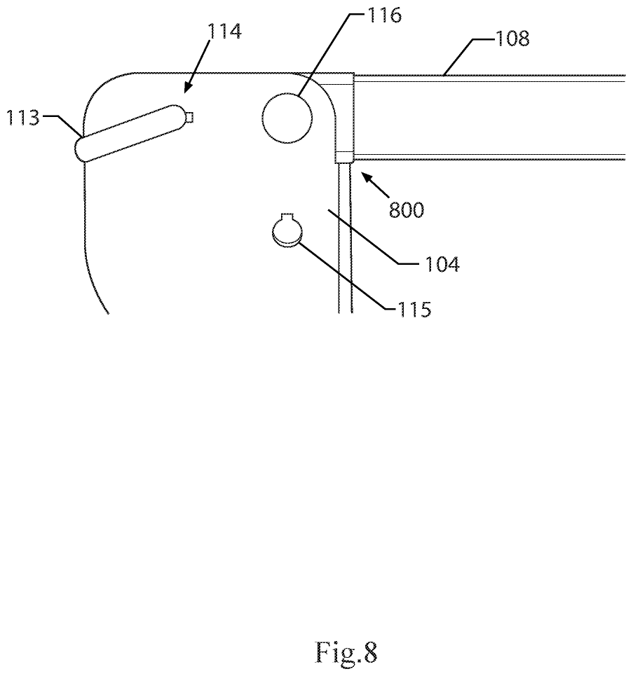

FIG. 8 is an illustration of a close-up side view of one embodiment of the clamping frame base hinge/bracket with the clamping post in a stowed position. FIG. 8 shows that the clamping frame base hinge/bracket 104 may comprise pivot bolt 116, holes 114, 115, and post stop portion 800. As shown, the clamping post 107 is locked into a stowed position by L pin 113 and is supported by post stop portion 800.

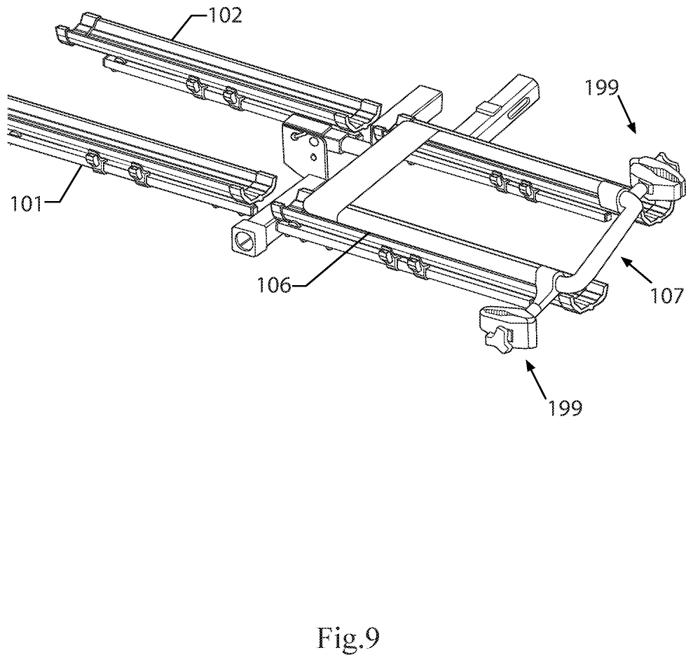

FIG. 9 is an illustration of a perspective view of one embodiment of the vehicle rack with the rotating post in a stowed position. FIG. 9 shows that the clamping tube 106 may matingly fit with the wheel support trays 101, 102 when the clamping post 107 is in the rotated and stowed position. FIG. 9 also shows how bike engagement portions 199 may be moved to an out of the way position when the clamping post 107 is rotated and stored.

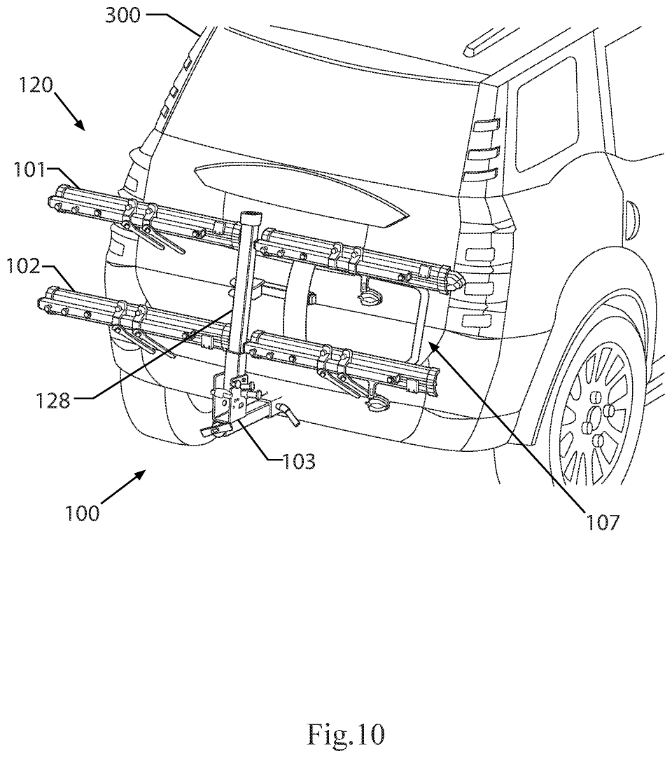

FIG. 10 is an illustration of a perspective view of one embodiment of the vehicle rack in a stowed position and attached to a vehicle. FIG. 10 shows that when the rack 100 is in the stowed position, the clamping post 107 rests unobtrusively within the wheel support trays 101, 102 and close to the vehicle 300. In this manner, the clamping post 107 does not block the rear windows of the vehicle 300 and the rack 100 is aesthetically pleasing. FIG. 10 also shows the wheel support beam 128 is hinged upward with respect to carrier foldup bracket 103.

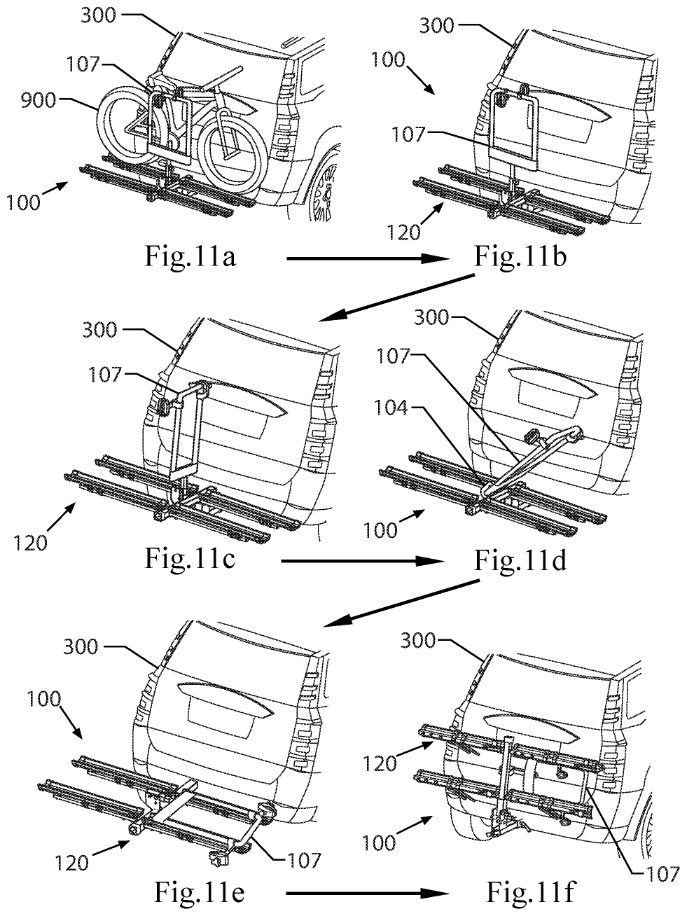

FIGS. 11a-f are a series of illustrations showing one embodiment of the vehicle rack going from a loaded position to a stowed position. FIG. 11a shows that the rack 100 is in use and has a bike that is attached to clamping post 107 and that the rack 100 is engaged with vehicle 300. FIG. 11b shows that the bike is removed. FIG. 11c shows that the clamping post 107 is rotated with respect to carrier base 120 and vehicle 300. FIG. 11d shows that once the clamping post 107 is rotated, it may be hinged down into a stowed position. FIG. 11e shows that the clamping post 107 may be put into a stowed position when rotated and hinged down. FIG. 11f shows that once the clamping post 107 is in a stowed position, the rack 100 may be put into a final stowed position.

Unless otherwise stated, all measurements, values, ratings, positions, magnitudes, sizes, locations, and other specifications, which set forth in this specification, including in the claims that follow, are approximate, not exact. They are intended to have a reasonable range, which is consistent with the functions to which they relate and with what is customary in the art to which they pertain.

The foregoing description of the preferred embodiment has been presented for the purposes of illustration and description. While multiple embodiments are disclosed, still other embodiments will become apparent to those skilled in the art from the above detailed description, which shows and describes the illustrative embodiments. As will be realized, these embodiments are capable of modifications in various obvious aspects, all without departing from the spirit and scope of the present disclosure. Accordingly, the detailed description is to be regarded as illustrative in nature and not restrictive. Also, although not explicitly recited, one or more additional embodiments may be practiced in combination or conjunction with one another. Furthermore, the reference or non-reference to a particular embodiment shall not be interpreted to limit the scope of protection. It is intended that the scope of protection not be limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

What is claimed is:

1. A vehicle rack comprising:
a carrier base;
a clamping post; and
a clamping frame base hinge/bracket;
wherein said clamping post comprises a clamping frame assembly, a clamping post housing, and a rotating post base;
wherein said carrier base is attached to and supports said clamping frame base hinge/bracket and wherein said clamping frame base hinge/bracket is attached to said clamping post housing;
wherein said clamping rotating post base is rotatable with respect to said clamping post housing and has at least two lockable positions, an in-use rotating post base position and a rotated rotating post base position;
wherein said post is configured to hinge with respect to said carrier base and has at least two positions, an in-use clamping post position and a stowed clamping post position; and
wherein said carrier base is configured to support a load and wherein said clamping frame assembly is configured to removeably engage with said load.

2. The vehicle rack of claim 1, further comprising a hitch stinger and a carrier foldup bracket;
wherein said hitch stinger is configured to removeably attach to a trailer hitch receiver of a vehicle;
wherein said carrier base comprises one or more wheel support trays and a wheel support beam;
wherein said wheel support beam is attached to said carrier foldup bracket;
wherein said hitch stinger is attached to said carrier foldup bracket, such that said carrier base is configured to hinge with respect to said hitch stinger, such that said vehicle rack has at least two positions, an in-use vehicle rack position and a stowed vehicle rack position.

3. The vehicle rack of claim 1, wherein said clamping post housing is pivotably attached to said clamping frame base hinge/bracket via a pivot bolt.

4. The vehicle rack of claim 1, wherein said clamping frame base hinge/bracket comprises an in-use hole and a stowed hole, which are configured to allow said clamping post to be locked into said in-use clamping post position and said stowed clamping post position.

5. The vehicle rack of claim 1, wherein said clamping post housing comprises a post lock;
wherein said rotating post base has at least one side index hole and at least one front index hole;
wherein said post lock is configured to engage, alternatively, with said at least one side index hole and said at least one front index hole, such that said rotating post base is configured to be locked into said in-use rotating post base position and said rotated rotating post post base position; and
wherein said in-use rotating post base position and said rotated clamping rotating post base position are approximately 90 degrees from each other.

6. The vehicle rack of claim 1, wherein said clamping frame assembly comprises a clamping tube and one or more bike engagement portions;
wherein said load is one or more bicycles.

7. The vehicle rack of claim 6, wherein said one or more bike engagement portions comprise a bike clamp, a frame clamp adapter, and a bike clamp position tube;
wherein said one or more bike engagement portions are configured to be adjustably connected to said clamping tube and are configured to releasably engage with said one or more bicycles.

8. A vehicle rack comprising:
a carrier base;
a clamping post;
a clamping frame base hinge/bracket;
a hitch stinger; and
a carrier foldup bracket;
wherein said clamping post comprises a clamping frame assembly, a clamping post housing, and a rotating post base;
wherein said carrier base is attached to and supports said clamping frame base hinge/bracket and wherein said clamping frame base hinge/bracket is hingedly attached to said clamping post housing via a pivot bolt;
wherein said rotating post base is rotatable with respect to said clamping post housing and has at least two lockable positions, an in-use rotating post base position and a rotated rotating post base position;
wherein said clamping post is configured to hinge with respect to said carrier base and has at least two lockable positions, an in-use clamping post position and a stowed clamping post position;
wherein said carrier base is configured to support a load and wherein said clamping frame assembly is configured to removeably engage with said load;
wherein said hitch stinger is configured to removeably attach to a trailer hitch receiver of a vehicle;
wherein said carrier base comprises one or more wheel support trays and a wheel support beam;
wherein said wheel support beam is attached to said carrier foldup bracket;
wherein said hitch stinger is attached to said carrier foldup bracket, such that said carrier base is configured to hinge with respect to said hitch stinger, such that said vehicle rack has at least two lockable positions, an in-use vehicle rack position and a stowed vehicle rack position;

9. The vehicle rack of claim 8, wherein said clamping frame base hinge/bracket comprises an in-use hole and a stowed hole, which are configured to allow said clamping post to be locked into said in-use clamping post position and said stowed clamping post position.

10. The vehicle rack of claim 9 wherein said clamping post housing comprises a post lock;
wherein said rotating post base has at least one side index hole and at least one front index hole;
wherein said post lock is configured to engage, alternatively, with said at least one side index hole and said at least one front index hole, such that said rotating post base is configured to be locked into said in-use rotating post base position and said rotated rotating post base position; and
wherein said in-use rotating post base position and said rotated clamping rotating post base position are approximately 90 degrees from each other.

11. The vehicle rack of claim 10, wherein said clamping frame assembly comprises a clamping tube and one or more bike engagement portions;
wherein said load is one or more bicycles.

12. The vehicle rack of claim 11, wherein said one or more bike engagement portions comprise a bike clamp, a frame clamp adapter, and a bike clamp position tube;
wherein said one or more bike engagement portions are configured to be adjustably and slidably connected to said clamping tube and are configured to releasably engage with said one or more bicycles.

13. The vehicle rack of claim 12, wherein when said clamping post is locked into said stowed clamping post position, said clamping tube matingly fit with said one or more wheel support trays.

14. A vehicle rack comprising:
a carrier base;
a clamping post; and
a clamping frame base hinge/bracket;
wherein said clamping post comprises a clamping frame assembly, a clamping post housing, and a rotating post base;
wherein said carrier base is attached to and supports said clamping frame base hinge/bracket and wherein said clamping frame base hinge/bracket is attached to said clamping post housing;
wherein said rotating post base is rotatable with respect to said clamping post housing and has at least two lockable positions, an in-use rotating post base position and a rotated rotating post base position;
wherein said clamping post is configured to hinge with respect to said carrier base and has at least two lockable positions, an in-use clamping post position and a stowed clamping post position;
wherein said carrier base is configured to support a load and wherein said clamping frame assembly is configured to removeably engage with said load;
wherein said clamping frame base hinge/bracket comprises an in-use hole and a stowed hole, which are configured to allow said clamping post to be locked into said in-use clamping post position and said stowed clamping post position.

15. The vehicle rack of claim 14, further comprising a hitch stinger and a carrier foldup bracket;
wherein said hitch stinger is configured to removeably attach to a trailer hitch receiver of a vehicle;
wherein said carrier base comprises one or more wheel support trays and a wheel support beam;
wherein said wheel support beam is attached to said carrier foldup bracket;
wherein said hitch stinger is attached to said carrier foldup bracket, such that said carrier base is configured to hinge with respect to said hitch stinger, such that said vehicle rack has at least two lockable positions, an in-use vehicle rack position and a stowed vehicle rack position.

16. The vehicle rack of claim 15, wherein said clamping post housing is hingedly attached to said clamping frame base hinge/bracket via a pivot bolt;

17. The vehicle rack of claim 16, wherein said clamping post housing comprises a post lock;
wherein said rotating post base has at least one side index hole and at least one front index hole;
wherein said post lock is configured to engage, alternatively, with said at least one side index hole and said at least one front index hole, such that said rotating post base is configured to be locked into said in-use rotating post base position and said rotated rotating post base position.

18. The vehicle rack of claim 17, wherein said clamping frame assembly comprises a clamping tube and one or more bike engagement portions;
wherein said load is one or more bicycles.

19. The vehicle rack of claim 18, wherein said one or more bike engagement portions comprise a bike clamp, a frame clamp adapter, and a bike clamp position tube;
wherein said one or more bike engagement portions are configured to be adjustably connected to said clamping tube and are configured to releasably engage with said one or more bicycles.

20. The vehicle rack of claim 19, wherein said in-use rotating post base position and said rotated rotating post base position are approximately 90 degrees from each other.
